(19) United States
(12) Patent Application Publication
(10) Pub. No.: US 2011/0074199 A1
(43) Pub. Date: Mar. 31, 2011

(54) ADJUSTABLE VEHICLE SEAT AND METHOD

(75) Inventors: Erik Sprenger, Remscheid (DE); Stefan Heuel, Wuppertal (DE); Salih Yilmaz, Koln (DE)

(73) Assignee: Johnson Controls GmbH, Burscheid (DE)

(21) Appl. No.: 12/160,592

(22) PCT Filed: Jan. 11, 2007
(86) PCT No.: PCT/EP2007/000204

§ 371 Date: Dec. 2, 2010

(30) Foreign Application Priority Data
Jan. 11, 2006 (DE) 10 2006 001 591.6

(51) Int. Cl. B60N 2/20; B60N 2/22

(52) U.S. Cl. 297/361.1

(57) ABSTRACT

An adjustable seat for a vehicle includes a seat part that is moveable between a first seat position and a second seat position. The first seat position is spaced a first predetermined distance from a floor of the vehicle and the second seat position is spaced a second predetermined distance from the floor of the vehicle. A backrest pivotally connected to the seat part about a pivot axis. An adjusting device is operatively connected to the seat part for moving the seat part between the first seat position and the second seat position. The adjusting device includes an energy storage mechanism that exerts a variable first force on the seat part by pivoting the backrest from a folded over position to an upright position to move the seat part from the second seat position to the first seat position.

### CROSS REFERENCE TO RELATED APPLICATIONS

The present application is a National Stage filing of International Application No. PCT/EP2007/000204, filed on Jan. 11, 2007, titled “Lowerable Vehicle Seat with a Collapsible Backrest Part and Associated Method” which claims priority to German Patent Application No. DE 10 2006 001 591.6, filed Jan. 11, 2006, the entire disclosures of which are incorporated herein by reference.

### BACKGROUND OF THE INVENTION

The present invention relates generally to a vehicle seat, in particular to a vehicle seat which is adjustable within multiple positions and a method therefore.

Vehicle seats typically offer a high level of comfort for vehicle users. At the same time, the vehicle seat should be compact, functional and cost-effective to produce. The seat should also be intuitive to operate, with minimal effort. The seat may be multi-positional, such as having a backrest can be folded forward, with the seat part simultaneously lowered. By lowering the seat to floor level, a level surface may be created. In another example, the seat may be raised to provide a table surface. In still another example, the height-adjustable vehicle seat may partially compensate for the weight of the user sitting on the seat and thereby make the adjustment of the seat easier.

While these seats are functional, they may not be not compact in a stowed position and do not offer both simple and intuitive height adjustability of the vehicle seat in a seated position. Thus, there is a need in the art for a compact seat that is multi-positional with minimal user effort and in an ergonomic manner.

### SUMMARY

Accordingly, an adjustable seat for a vehicle includes a seat part that is moveable between a first seat position and a second seat position. The first seat position is spaced a first predetermined distance from a floor of the vehicle and the second seat position is spaced a second predetermined distance from the floor of the vehicle. A backrest pivotally connected to the seat part about a pivot axis. An adjusting device is operatively connected to the seat part for moving the seat part between the first seat position and the second seat position. The adjusting device includes an energy storage mechanism that exerts a variable first force on the seat part by pivoting the backrest from a folded over position to an upright position to move the seat part from the second seat position to the first seat position.

Other features and advantages of the present disclosure will be readily appreciated, as the same becomes better understood in view of the subsequent description taken in conjunction with the accompanying drawings.

### BRIEF DESCRIPTION OF THE DRAWINGS

FIG. 1 is a side view of a vehicle seat in a first seat position.

FIG. 2 is a side view of the backrest partially folded over in the first seat position for the vehicle seat of FIG. 1.

FIG. 3 is a side view of a folded over backrest in the first seat position for the vehicle seat of FIG. 1.

FIG. 4 is a side view of the vehicle seat of FIG. 1 in a second seat position.

FIG. 5 is a side view of the vehicle seat of Figure illustrating another adjusting mechanism for varying the seat position.

FIG. 6 is a side view of the vehicle seat illustrating a control mechanism for the vehicle seat of FIG. 5.

FIG. 7 is another side view of the vehicle seat of FIG. 5 illustrating the adjustment mechanism for varying the seat position.

FIG. 8 is another side view of the vehicle seat of FIG. 7 illustrating the backrest in an upright position.

FIG. 9 is a side view of another example of an adjustment mechanism for varying the seat position.

FIG. 10 is a side view of the adjusting mechanism of FIG. 9 with the seat in a second seat position.

### DESCRIPTION

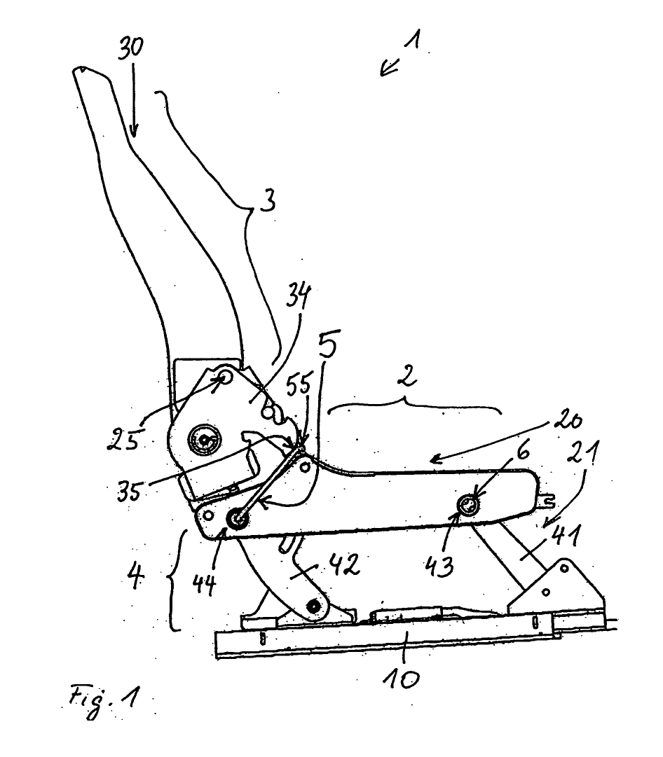

Referring to FIG. 1, a seat 1 for a vehicle is illustrated. The vehicle seat 1 may be a vehicle seat for the first, second or third row of a motor vehicle. The vehicle seat is multifunctional, and can be placed into various positions, such as a compact, stowed or lowered position. In such a position for example, a flat floor space is created in the forward direction. In another position, the vehicle seat can, with the back rest in a folded-over position, be used as a table.

The vehicle seat 1 includes a seat part 2 and a backrest 3, with the backrest 3 being movable relative to the seat part 2. The seat part 2 has a first main seat surface 20 which may be padded. The backrest 3 forms a second main seat surface 30 which may likewise be padded. In FIG. 1, the first main seat surface 20 runs substantially horizontally, or parallel to the seat part 2, while the second main seat surface 30 is substantially parallel to the backrest 3. The backrest 3 may be pivotable about a pivot axis 25 which runs substantially parallel both to the first and also to the second main seat surfaces 20, 30. The backrest 3 may therefore be pivoted onto the first main seat surface 20, or onto the seat part 2, by being pivoted about the pivot axis 25 from an upright position to a folded over position. In the folded over position, an outer surface 31 of the backrest 3 is substantially horizontal to a floor 11 of the vehicle.

The vehicle seat 1 also includes an adjustment device 4 for varying a position of the seat. For example, a height of the seat part or an inclination of the backrest may be varied. In this example, the adjustment device 4 includes a plurality of members or links which are secured to a seat subassembly 10 that is mounted to a floor of the vehicle. The adjustment device 4 includes a front link 41 and a rear link 42 that rotates relative to the seat part 2 and relative to the seat subassembly 10 of the vehicle to provide a height adjustment or an incline adjustment of the seat part 2, or of the seat part 2 together with the backrest 3. In another example, the adjustment device 4 provides an incline adjustment of the seat using a single pair of links. In another example, the front and rear links 41, 42 are provided substantially in pairs at the sides of the vehicle seat 1. However, in another example, a single link at the front or a single link at the rear, or else with a single link both at the front and at the rear of the seat is utilized.

The adjustment device 4 is connected to the seat part 2, for example using tubular components that are operatively connected to the links 41, 42. Tubular components are illustrated in FIG. 1 by the reference sign 43 for the front link(s) 41 and with the reference sign 44 for the rear link(s) 42.

The adjustment device includes an energy storage mechanism 5, which moves the seat part 2 between predetermined seat positions. In the first position, the seat part 2 is spaced a predetermined distance apart from the floor 11 of the vehicle and is located for receiving a seated user. Various types of energy storage mechanisms may be utilized to facilitate movement of the seat between the seat positions, such as a spring or the like. An example of an energy storage mechanism is a torsion spring 5. The torsion spring 5 of this example has a torsional axis which is substantially parallel and concentric with respect to the rear tubular component 44, The torsion spring also includes a lever arm 55, by which the torsional spring 5 can be rotated and thereby loaded or unloaded. The adjustment device 4 also includes a control member 34 having a control surface 35, and that is operatively connected to the backrest 3, such that the lever arm 55 of the spring 5 may be moved by the control surface 35 of the control member 34 to change the force action exerted by the spring 5.

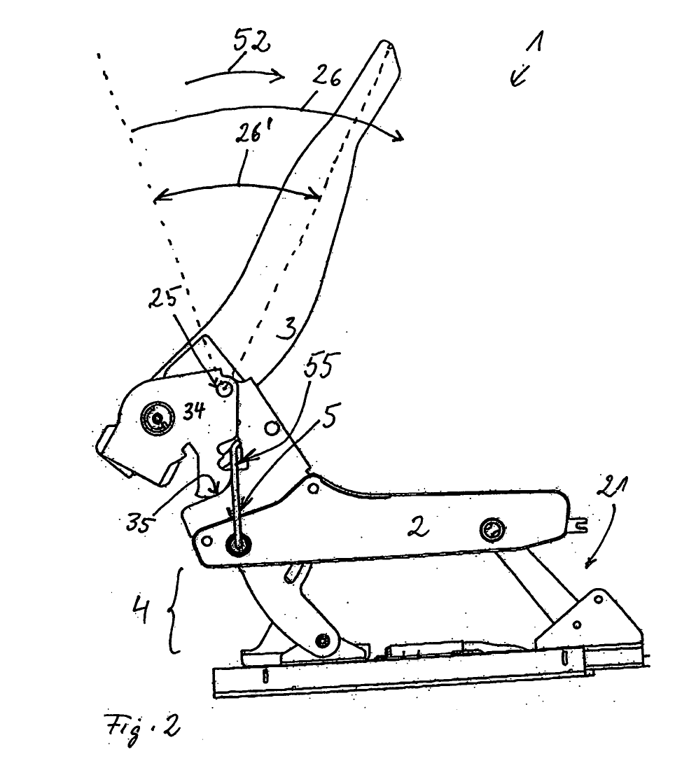

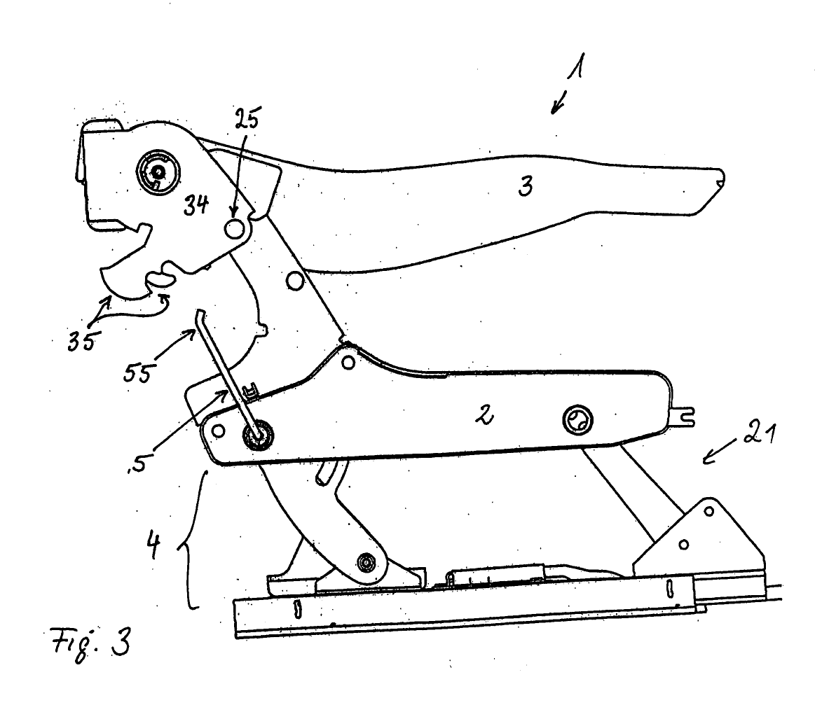

Referring to FIG. 2, the vehicle seat 1 with the seat part 2, the backrest 3, the pivot axis 25, the control element 34, the adjustment device 4 and the spring 5 are illustrated with the backrest pivoted by a predetermined angle 26′ in the direction of the seat part 2. In this position, the control means 34 and the control surface 35 of the control means 34 are likewise pivoted together with the backrest 3, such that the spring 5 and lever arm 55 are rotated counterclockwise relative to the position shown in FIG. 1. As a result, the spring 5 returns to a no load state. If the backrest 3 is pivoted even further to a predetermined inclined angle 26, the spring 5 assumes an unloaded or relaxed position illustrated in FIG. 3. The predetermined inclined angle 26 separates a first pivoting range with the spring 5 activated from the second pivoting range with the spring 5 deactivated.

In operation, a first force action of the spring 5, which causes the seat part 2 to be set in the first position, may be reduced or removed entirely. At the same time, the spring 5 exerts a second force 52 on the backrest 3. The backrest 3 may be set in a locked position about the pivot axis 25, because the second force action 52 locates the backrest 3 into a locked position, even if the backrest 3 was briefly set in an undefined or unlocked position. The second force action 52 occurs due to the positioning of the pivot axis 25, and the positioning of a contact point of the spring 5 with the control surface 35, and due to the torsional axis of the spring 5. If an angle of greater than 90° is present, the load of the spring 5 generates the second force action 52 which drives the backrest 3 forward.

Referring back to FIG. 3 the vehicle seat 1 is in a first seat position, with the backrest 3 pivoted or folder over toward the seat part 2. In this position, the lever arm 55 of the spring 5 is fully released and the spring 5 is in a substantially fully relaxed, or non-preloaded, state.

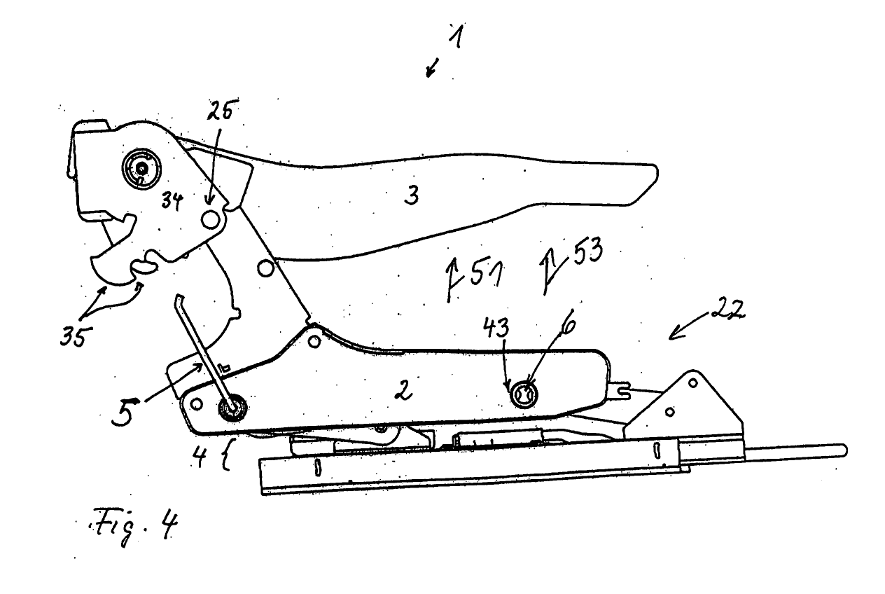

Referring to FIG. 4, the vehicle seat 1 is located in a lowered position with respect to a floor 11 of the vehicle, also referred to as a second seat position 22. The second seat position of the seat part 2 relative to the seat subassembly 10 of floor 11 is spaced a predetermined distance from the first seat position 21. The first force action shown at 51 causes the spring 5 to drive the seat part 2 from its second seat position 22 to its first seat position 21. Therefore, the first force action compensates for the body weight of a vehicle user sitting on the seat.

For example, the spring action and therefore the first and second force action 51, 52 of the spring 5 occurs since the rear tubular component 44 is rotatably and fixedly connected to the end of the spring 5 that is opposite the lever arm 55. The rear tubular component 44 moves or rotates together with the rear links 42. When setting the second seat position 22 of the seat part 2 from the first seat position 21, a torque is exerted on the spring 5, and i.e. a torque vector is directed outwardly. As a result of the positioning of the control surface 35, the first force action 51 is exerted on the seat part 2.

The system also includes a second energy storage mechanism, which in this example is a spring 6, arranged on the front tubular component 43. The second spring 6 constantly, regardless of the backrest position, exerts a third force as shown at 53. The third force is parallel to the first force action 51 on the seat part 2.

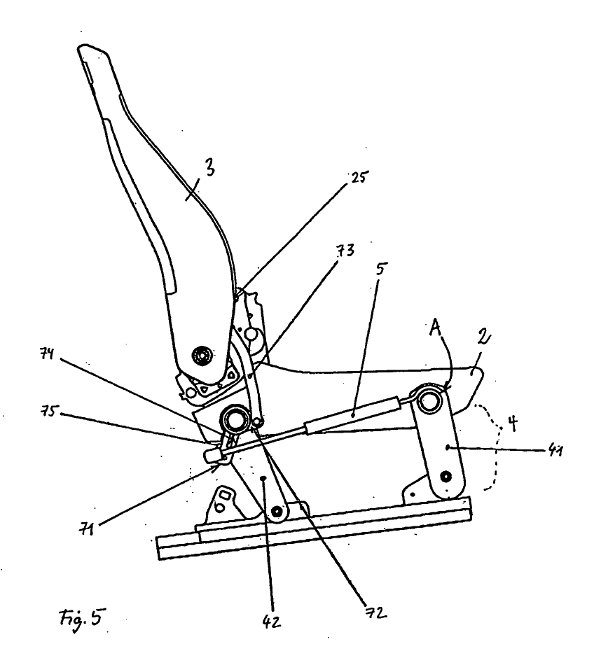

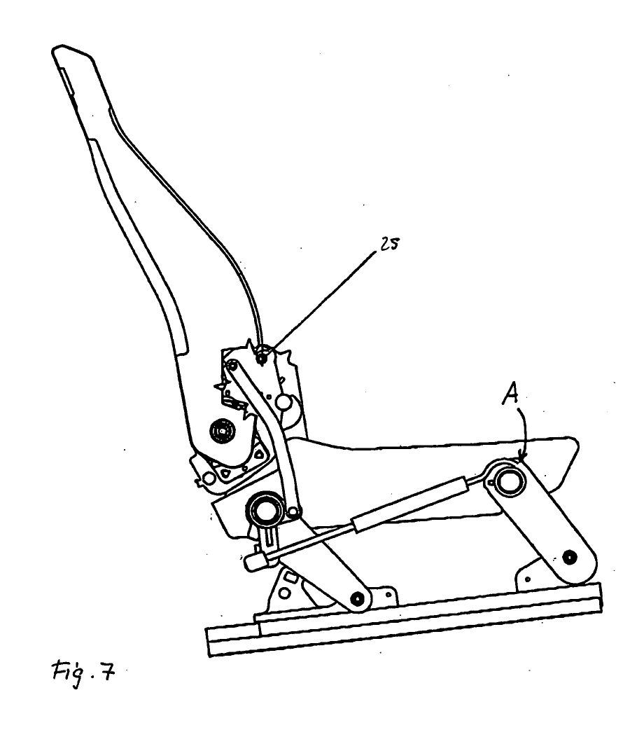

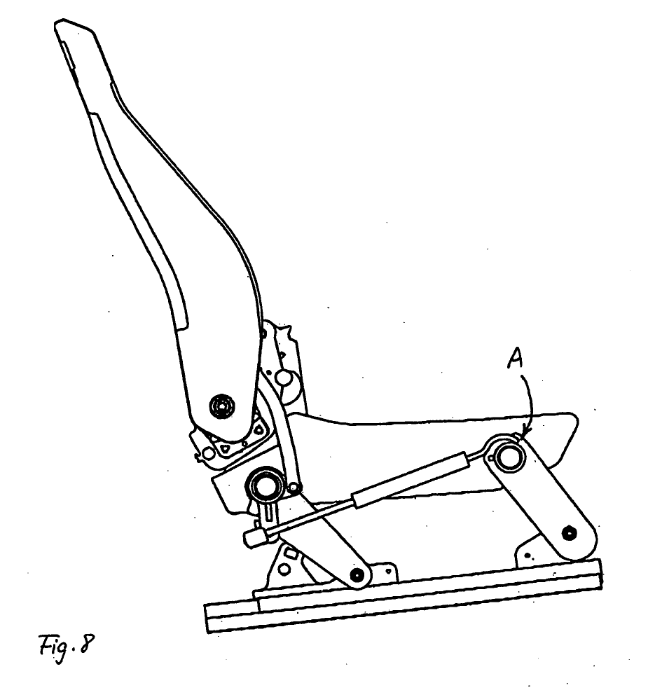

Referring to FIGS. 5 to 10, another example of an adjustable vehicle seat 1 is illustrated. In this example, the adjustment device 4 includes a plurality of rockers or links, with only the front link 41 and the rear link 42 being illustrated. The energy storage mechanism or spring 5 of this example is located between the front link 41 and the rear link 42 of the adjustment device 4. A front articulation point of the spring 5 on the front link 41 is located closer to a center of rotation of the front link 41, for example at the seat side, than the articulation point of the spring element 5 to a corresponding center of rotation of the rear link 42. The force action of the spring 5 on the front link 41 takes place with a smaller lever arm, such that a predefined force action of the spring 5 leads to a smaller torque at the front link than at the rear link. The articulation point of the spring 5 on the front link 41 is denoted by the reference symbol A in FIGS. 5 to 10.

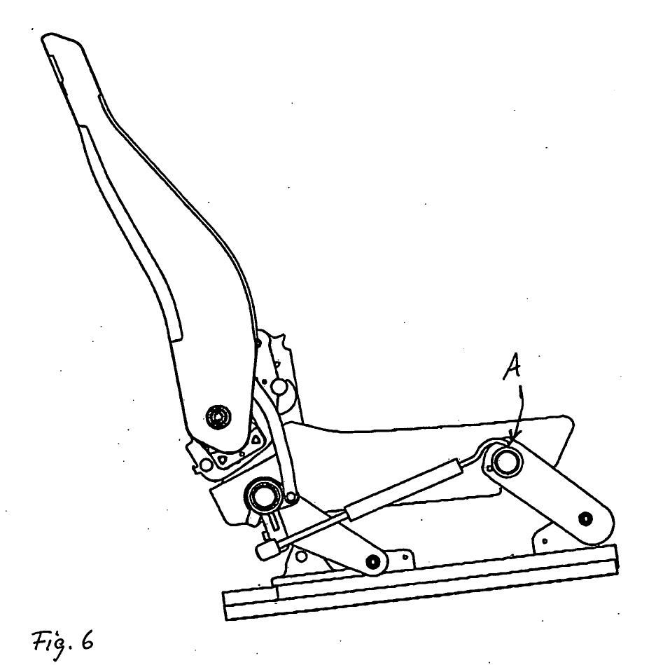

The spring may be connected to the rear link 42 using a first actuating lever 71 which may be freely rotatable with respect to the rear link 42. The rotation of the first actuating lever 71 with respect to the rear link 42 may be limited by a stop 75, such as a stop lug, in the clockwise rotational direction. The stop 75 or stop lug 75 is connected to the rear lever 42. If the first actuating lever 71 is set such that it abuts against the stop lug, the force action resulting from the load state in the spring 5, results in a torque exerted on the rear link 42 in a clockwise direction, so as to position the seat part 2 of the vehicle seat 1 in the upright position. The upright position of the backrest 3 is illustrated in FIGS. 5 to 8. FIGS. 6, 7 and 8 illustrate the vehicle seat 1 in different height settings of the seat part 2 relative to the height shown in FIG. 5 for the first seat position. The spring exerts a torque on the front link 41 and rear link 42, such that the weight of the vehicle seat 1, or the combined weight of the backrest 3, the seat part 2 and a portion of the adjustment device 4, is overcompensated for, such that the vehicle seat is set into a nominal seated position when it is empty, as illustrated in FIG. 5.

FIG. 5 also shows that the backrest 3 may also be pivotable about a pivot axis 25, which may be below a center of rotation of the table folding function. In this example, the position of the first actuating lever 71 and of a second actuating lever 72 is varied so that the spring 5 no longer exerts a torque on at least the rear link 42, because the first actuating lever 71 spaced apart from the stop 75.

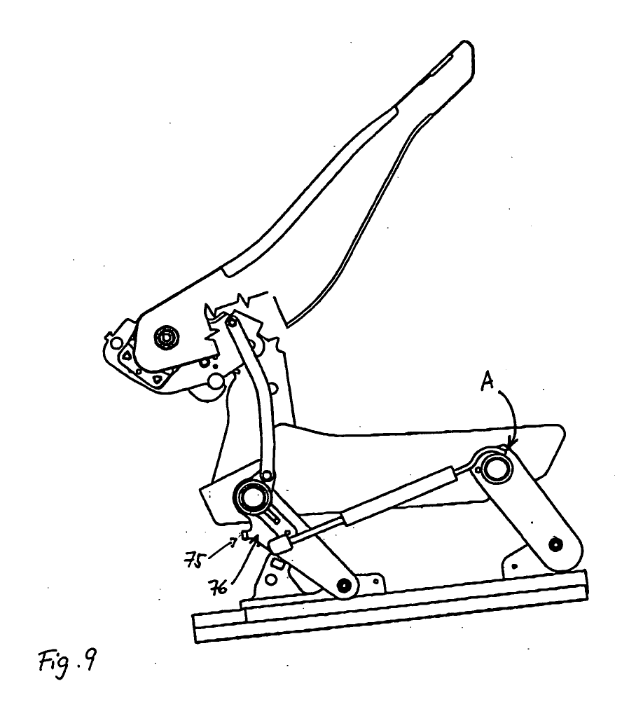

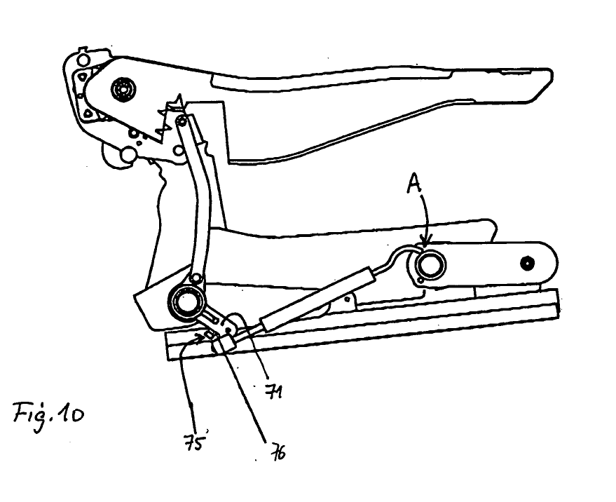

In FIG. 9 the backrest 3 is folded partially forward. The arrangement of the pull rod 73 relative to the pivot axis 25 effectively rotates the first actuating lever 71 due to the movement of the second actuating lever 72, such that the rear engagement point of the spring 5 is moved away from the stop 75 and can therefore no longer transmit torque to the rear link 42. This occurs when the backrest 3 is folded completely forward, regardless of a position of the seat part, including height and incline as shown in FIG. 10 by a spacing 76 between the stop 75 and the first actuating lever 71. The first actuating lever 71, the second actuating lever 72 and the pull rod are referred to as a control arrangement 7 which controls the exertion of torque by the spring 5 on the rear link 42. In another example, the pull rod 73 may be replaced by a cable or the like. In addition, the first actuating lever 71, also referred to as an intermediate lever, and the second actuating lever are integrally formed as one member. In this example, the control arrangement 7 includes both the first actuating lever 71 and also the second actuating lever 72. A contact portion between the intermediate lever and the second actuating lever 72 is shown at 74. If the pull rod 73 is pulled out of the position illustrated in FIG. 5, the second actuating lever 72 first rotates and, when the contact region 74 engages into the first actuating lever 71, the first actuating lever 71 also rotates (counterclockwise in FIG. 5), to form the space 76 between the first actuating lever with respect to the stop 75.

In a further example of an adjustment device, the energy storage mechanism 5 is a gas pressure spring or as a telescopic gas spring 5. The gas spring or telescopic gas spring 5 may be articulately connected to the front link 41, as shown at A. The gas spring, operatively raises or equalizes only a portion of the seat weight, so that the vehicle seat 1 automatically lowers from any seat position set by the adjustment device 4. An articulated connection of the spring 5 to the rear link 42 is provided with regard to the lever arm of the engagement point, with respect to the upper rotary bearing of the rear link 42 or lever arm 42. Due to the force action of the spring 5, the torque exerted is so large that the vehicle seat 1 is automatically pushed upward, or set in an upright position, from any seat position. Actuation of the control arrangement 7 by folding over the backrest 3 engages the spring 5 to create the space 76. The spring 5 can no longer raise the vehicle seat at the rear link 42, and the vehicle seat will lower downward in a braked or damped fashion as a result of the comparatively small lever arm of the spring 5 at the front link 41, as shown at engagement point A. If the backrest 3 is set upright again, such as when the vehicle seat 1 is in a lowered second seat position, the control arrangement 7 is actuated in such a way that the starting position illustrated in FIG. 5 is assumed. The spring 5, at the stop 75, exerts a torque on the rear lever 42 so as to raise the vehicle seat to the first seat position.

The present disclosure has been described as an illustrative manner. It is to be understood that the terminology which has been used is intended to be in the nature of words of description rather than of limitation.

Many modifications and variations of the present disclosure are possible in light of the above teachings. Therefore, the present disclosure may be practiced other than as specifically described.

What is claimed is:

1. An adjustable seat for a vehicle comprising:
a seat part that is moveable between a first seat position and a second seat position, wherein the first seat position is spaced a first predetermined distance from a floor of the vehicle and the second seat position is spaced a second predetermined distance from the floor of the vehicle;
a backrest pivotally connected to the seat part about a pivot axis;
an adjusting device operatively connected to the seat part for moving the seat part between the first seat position and the second seat position, wherein the adjusting device includes an energy storage mechanism that exerts a variable first force on the seat part when pivoting the backrest from a folded over position to an upright position to move the seat part from the second seat position to the first seat position.

2. The vehicle seat of claim 1, wherein the adjusting device includes a front link pivotally connected between a seat subassembly mounted to the floor of the vehicle and a front end of the seat part and a rear link pivotally connected between the seat subassembly and a rear end of the the seat part, and the energy storage mechanism is a spring that imparts the first force by exerting a torque on either the front link or the rear link.

3. The vehicle seat as set forth in claim 2, wherein the spring is operatively connected to the front link or the rear link such that a greater torque is exerted on the rear link than on the front link.

4. The vehicle seat as set forth in claim 1, further comprising a control arrangement having a pull rod rotatably connected to an actuating lever interconnecting the energy storage mechanism and the rear link, such that the control arrangement operatively controls the torque exerted on the rear link by the energy storage mechanism as the backrest is moved to an upright position from a folded over position.

5. The vehicle seat as set forth in claim 4, wherein the energy storage mechanism is a gas assisted spring.

6. (canceled)

7. The vehicle seat as set forth in claim 1, wherein the first force generated by the energy storage mechanism is reduced as the backrest pivots about the pivot axis towards the seat part by a predefined angle.

8. The vehicle seat as set forth in claim 1, further comprising a second force exerted by the energy storage mechanism that pivots the backrest about the pivot axis in the direction of the seat part.

9. The vehicle seat as set forth in claim 1, further comprising a second spring connected to the seat part that exerts a third force on the seat part that moves the seat part from the second seat position to the first seat position, and the third force is independent of pivotal movement of the backrest relative to the seat part.

10. The vehicle seat as set forth in claim 9, wherein the second spring mechanism is a torsion spring.

11. The vehicle seat as set forth in claim 1 further comprising a control member pivotally connected to the seat back about the pivot axis, wherein the control member includes a control surface that operatively engages the energy storage mechanism.

12. The vehicle seat as set forth in claim 1 wherein a rear surface of the backrest is generally horizontal in a folded over position the backrest.

13. A method for adjusting a vehicle seat between a raised first seat position and a lowered second seat position, said method comprising the steps of
providing a backrest pivotally connected to a seat part about a pivot axis in a first seat position whereby the seat part is spaced a first predetermined distance from a floor of the vehicle in the first seat position and the backrest is pivotal between an upright position and a folded over position;
pivoting the backrest into the folded over position to move the seat part to a second seat position, whereby the seat cushion is spaced a second predetermined distance from the floor of the vehicle in the second position, using an adjustment mechanism having an energy storage mechanism that exerts a constant first force on the seat part; and
returning the seat part to the first seat position by pivoting the backrest to the upright position by varying the first force exerted by the energy storage mechanism on the backrest.

14. An adjustable seat for a vehicle comprising:
a seat part that is moveable between a first seat position and a second seat position, wherein the first seat position is spaced a first predetermined distance from a floor of the vehicle and the second seat position is spaced a second predetermined distance from the floor of the vehicle;
a backrest pivotally connected to the seat part about a pivot axis;
an adjustment device operatively connected to the seat part for moving the seat part between the first seat position and the second seat position, having a front link pivotally connected between a seat subassembly mounted to the floor of the vehicle and a front end of the seat part and a rear link pivotally connected between the seat subassembly and a rear end of the seat part, and a spring operatively connected to the seat part that imparts a variable first force on the seat part by exerting a torque on either the front link or the rear link when pivoting the backrest from a folded over position to an upright position to move the seat part from the second seat position to the first seat position.

15. The vehicle seat as set forth in claim 14, wherein the spring is a torsion spring having a torsional axis that is parallel to and concentric with a tubular component interconnecting the seat part with the rear link and a lever arm by which the torsion spring is rotated, such that a greater torque is exerted on the rear link than on the front link.

16. The vehicle seat as set forth in 15, further comprising a control member pivotally connected to the backrest to pivot about the pivot axis, wherein the control member includes a control surface adjacent the spring lever arm, and pivoting of the backrest pivots the control member to move the spring lever arm and vary the first force.

17. The vehicle seat as set forth in claim 14, wherein the first force generated by the spring is reduced as the backrest pivots about the pivot axis towards the seat part by at a predefined angle, and the first force is zero when the backrest is in a folded over position.

18. The vehicle seat as set forth in claim 17, further comprising a second force exerted by the spring on the backrest that pivots the backrest forwardly about the pivot axis towards the seat part.

19. The vehicle seat as set forth in claim 14, wherein an end of the spring is connected to the rear link via a rotatable actuating lever, and the other end of the spring is connected to the front link, such that a torque exerted on the rear link in a clockwise direction positions the backrest in an upright position.

20. The vehicle seat as set forth in claim 19, wherein the spring is a gas assisted spring.
